(19) United States
(12) Patent Application Publication
(10) Pub. No.: US 2005/0041736 A1
(43) Pub. Date: Feb. 24, 2005

(54) Stereoscopic television signal processing method, transmission system and viewer enhancements

(76) Inventors: Bernie Butler-Smith, Malibu Lake, CA (US); Steve Schklair, Altadena, CA (US)

Correspondence Address: BAKER & HOSTETLER LLP;Washington Square, Suite 1100, 1050 Connecticut Avenue, N.W., Washington, DC, 20036, US

(21) Appl. No.: 10/840,592

(22) Filed: May 7, 2004

Related U.S. Application Data
(60) Provisional application No. 60/468,260, filed on May 7, 2003.

(51) Int. Cl. H04N 7/12

(52) U.S. Cl. 375/240.01; 348/42; 348/36

(57) ABSTRACT

This invention provides a method of combining two standard video streams, into one standard video stream, in such a way that it can be encoded efficiently, and that it can enhance the TV viewing experience by presenting Stereoscopic 3D imagery, dual-view display capability, panoramic viewing, and user interactive “pan-and-scan”. The video standards for High Definition Video are used, which are governed by the ATSC and SMPTE standards bodies. Having a dual stream of standard video, which occupies now a single stream of standard video, provides a means to use the standard installed base of equipment for recording, transmission, playback and display.

### CROSS-REFERENCE TO RELATED APPLICATIONS

This application claims priority to and is a non-provisional of U.S. provisional patent application entitled, Stereoscopic 3D TV System: End-to-End Solution, filed May 7, 2003, having a Ser. No. 60/468,260, the disclosure of which is hereby incorporated by reference in its entirety.

### FIELD OF THE INVENTION

The present invention relates generally to a method used to combine dual streams of video into a standard single stream of video. More particularly, the present invention relates to a method of combining a dual stream of standard video, to occupy a single stream of standard video, providing a means to enhance a viewers experience in several ways.

### BACKGROUND OF THE INVENTION

There are various methods, and prior art, used to combine dual streams of video into a standard single stream of video, and many of these inventions are concentrated on the displaying of Stereoscopic 3D content on a display device.

The methods typically use field-sequential multiplexing, spectral multiplexing, spatial-multiplexing by compressing the image in horizontal or vertical directions, anaglyph, vertical retrace data insertion, horizontal disparity encoding, compression bases on differenced signals, vector mapping, MPEG IPB block vectors, DCT transformations, and rate control.

The video standards are now rapidly being replaced by digital, and high-definition standards. The ATSC (Advanced Television Systems Committee) and SMPTE (Society of Motion Picture and Television Engineers) are the two main standards governing bodies, and the FCC (Federal Communications Committee) has mandated a timeline for these standards to be implemented by broadcasters, and television manufacturers.

Working in the digital domain, allows an inventor to create many new and exciting technologies that have been enabled by this transition into digital video. This invention describes a method of combining a dual stream of standard video, to occupy a single stream of standard video, providing a means to enhance a viewers experience in several ways.

### SUMMARY OF THE INVENTION

This invention provides a method of combining two standard video streams, into one standard video stream, by tiling two lower resolution images frames into one higher resolution image frame, without loss of pixel data. There are various HDTV standards that will accommodate this tiling method, which is done by mapping pixel data from two lower resolution frames into new pixel positions of a single higher resolution frame. This is done by tiling the higher resolution frame, with segments of the two lower resolution frames.

When two camera views are encoded for Stereoscopic 3D applications, or panoramic applications, or pan-and-scan applications, this tiling will ensure in most cases, that when there is camera movement from one camera, the other camera will have movement in the same vector direction. Also this tiling will ensure in most cases, that when there is no camera movement from one camera, the other camera will have no movement as well.

This tiling method is therefore advantageous for the compression of the tiled frame sequence, by compression algorithms such as MPEG-2, MPEG4, and WM-9, which rely on temporal redundancy to encode more efficiently.

Other methods of combining two streams of video by field interleaving, or interlacing, on the other hand, generate frames which are not efficient to encode by most compression algorithms.

Having encoded the “tiled” frame, and having the sequence of such frames compressed by an acceptable video compression algorithm, allows this data to be handled just as though it was a single source feed, by means of storage onto tape, memory or disk surface, to be transmitted by terrestrial, cable, or satellite head ends, and received by other head ends, or set-top-boxes.

The set-top-box, TV, media player, or PC, or other dedicated decoding device, can be used to decode this “tiled” imagery back into two streams of standard video, to be displayed on a display device, such as a TV, projector, or computer monitor.

This display device may have one or more capabilities to present to the viewer, several modes which are possible, and described in this invention as “2D Mode”, “Dual-View” mode, “Pan-and-Scan Mode”, and “Stereoscopic 3D Mode”

### BRIEF DESCRIPTION OF THE DRAWINGS

For a better understanding of the present invention, reference is made to the following descriptions taken in conjunction with the accompanying drawings, in which, by example: FIG. 1 shows the first video source, with a frame resolution of 1280×720 pixels, which could be the “left-eye” view of a Stereoscopic image pair, for example. This resolution is an ATSC and SMPTE video standard. This frame will be encoded into the higher resolution frame of [FIG. 3] FIG. 1 is labeled “Left-Eye” to distinguish it from the second video source, by example.

FIG. 2 shows the second video source, with a frame resolution of 1280×720 pixels, which could be the “right-eye” view of a Stereoscopic image pair, for example. This resolution is an ATSC and SMPTE video standard. This frame will be encoded into the higher resolution frame of [FIG. 3]

FIG. 2 is labeled “Right-Eye” to distinguish it from the first video source, by example.

FIG. 3 shows the combined pair of video frames of [FIG. 1] and [FIG. 2], as a “tiled” frame having a resolution of 1920×1080, which could constitute the Stereoscopic image pair, for example. This resolution is an ATSC and SMPTE video standard.

FIG. 3 is considered the encoded “tiled” frame. It is a typical layout for the tiling, but is not limited to this arrangement of tiled segments.

The bottom right hand corner of FIG. 3, which occupies 1/9th of the area of the frame, or 640×360 pixels, may be used to insert additional imagery, such as a thumbnail sub-frame, or areas of the imagery adjacent to the stitched areas of the tiling, if this improves the compression efficiency.

### DETAILED DESCRIPTION

To combine two standard source video streams into one standard output video stream, each video stream [FIG. 1,2] is first digitized to an associated memory buffer. The memory buffers are updated for each incoming video stream, on a pixel-by-pixel sequential basis.

The memory buffers can be in a dual-ported FIFO configuration, or single-ported SRAM or VRAM configuration, as long as the bus bandwidth for writing and reading the memory is sufficient to satisfy a simultaneous read and write cycle, and read/write address contention is avoided by hardware, or bank-switched (toggled) to ensure no contention.

The re-mapping of pixel data from two lower-resolution input frames [FIG. 1,2] into pixel data of the tiled higher resolution output frame [FIG. 3] can be performed in one of two ways:

Firstly, the write cycles into the memory from each input frame [FIG. 1,2] are linearly addressed, and the read cycles have an address generator which transposes the address to match the sequence required to tile the output frame [FIG. 3]. In this case the memory buffer needs to have the capacity to hold two input video frames, or four input frames if the contention avoidance is created by bank switching.

Secondly, the write cycles into the memory from each input frame [FIG. 1,2] are addressed by an address generator, which transposes the write address, such that the output read cycles for the output tiled frame [FIG. 3] will be linearly addressed. In this case the memory buffer needs to have the capacity to hold a single output tiled frame, or two output frames if the contention avoidance is created by bank switching.

In all cases it must be assured by the methods described above, or by any other method, that the read-out of the tiled frame [FIG. 3] from memory, never reads across a boundary of stored input frames [FIG. 1,2] captured at different times.

The input source frames [FIG. 1,2] are typically gen-locked together to ensure this memory model works.

The above method describes a hardware method of combining two sources frames [FIG. 1,2] to an output tiled frame [FIG. 3]. This operation may also be done by rendering the frames in software to render the same output frame [FIG. 3] from the two source frames [FIG. 1,2] stored in a computer's memory, or on a disk.

There are various HDTV standards that will accommodate this tiling method, which is done by mapping pixel data from two lower resolution frames into new pixel positions of a single higher resolution tiled frame, without loss of pixel data.

The pixel resolution of these standards presently include (horizontal×vertical):
1) 1920×1080
2) 1280×720
3) 704×480
4) 640×480

In the example provided in the drawings, and their descriptions, two frames of 1280×720 can be tiled into a frame of 1920×1080. It is similarly possible to tile two frames of 640×480 into a frame of 1280×720.

In these examples, pixel data is not lost, but it is also possible to reduce the size of the input frames to match the tiling requirements of the output tiled frame, in which case pixel interpolation will be required, and some pixel data will be lost in this conversion.

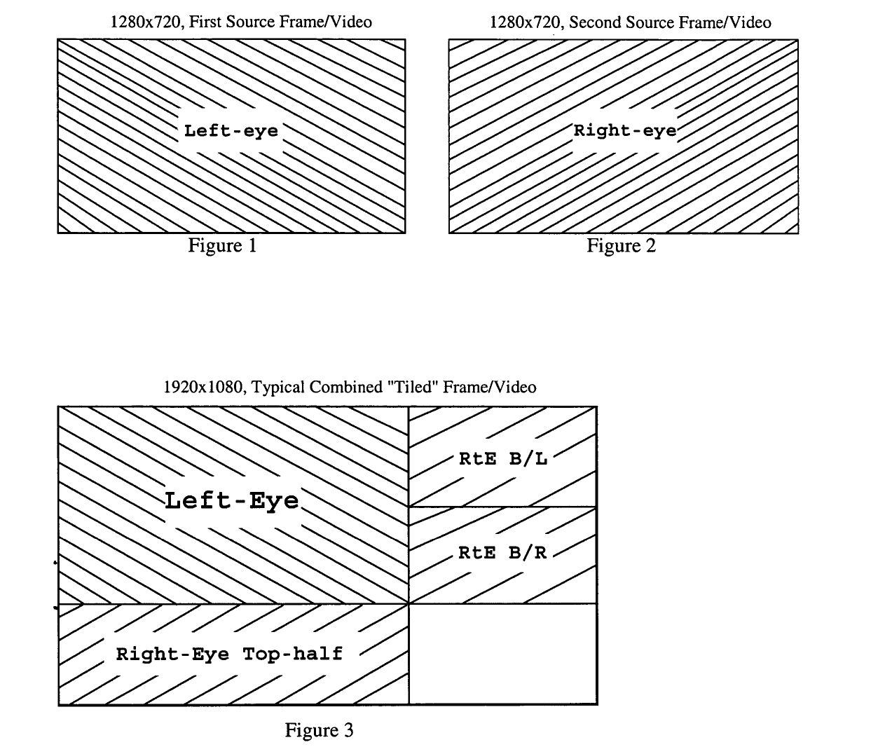

When two camera views are encoded for Stereoscopic 3D applications [FIG. 1,2], or panoramic applications, or pan-and-scan applications, this tiling method, and the output frame generated [FIG. 3], will ensure in most cases, that when there is camera movement from one camera [FIG. 1], the other camera [FIG. 2] will have movement in the same vector direction. Also this tiling [FIG. 3] will ensure in most cases, that when there is no camera movement from one camera [FIG. 1], the other camera [FIG. 2] will normally have no movement as well.

This tiling method is therefore advantageous for the compression of the tiled frame sequence, by video compression algorithms such as MPEG-2, MPEG-4, and WM-9, which rely on temporal redundancy to encode more efficiently. To the compression CODEC (coder-decoder), the input imagery will appear to come from a single camera source.

Most video compression algorithms have difficulty in efficiently encoding most other methods of combined imagery from two sources, such as field interleaving, or interlacing.

Having encoded the “tiled” frame [FIG. 3], and having the sequence of such frames compressed by an acceptable video compression algorithm, allows this data to be handled just as though it was a single source feed, or single camera.

Presently most of the broadcast infrastructure uses MPEG-2 as the compression algorithm of choice.

This may change as better algorithms become available. By having a the tiled video [FIG. 3] encoded as a MPEG-2 stream, allows all the infrastructure that supports MPEG-2 to be used for compression, storage, recording, archiving, transmission, reception, and decompression, to be used unaltered.

The tiled video, after it is decompressed into a single stream of tiled video [FIG. 3], needs to be decoded back into dual streams of video [FIG. 1,2] just prior to viewing on a display device, such as a TV, projector, or computer monitor.

This can be performed in a set-top-box in a consumer application, a media player, a PC, or other dedicated decoding device.

This display device may have one or more capabilities to present to the viewer, several modes which are possible, and described in this invention as “2D Mode”, “Dual-View” mode, “Pan-and-Scan Mode”, and “Stereoscopic 3D Mode”

“2D Mode” is a mode that displays a single stream of decoded video. Either [FIG. 1] or [FIG. 2] just like regular 2D Video. The decoder presents to the display just one fixed source of video.

“Dual-View Mode” is a mode that allows the viewer to select one of the two sources from the decoder, just like an A/B switch selecting a source of either [FIG. 1] or [FIG. 2]. The input to the display can multiplex from one source to the other. The viewer can manually select, from two camera views that have been encoded, for example.

“Pan-and-Scan Mode” is a mode in which the source material of the encoded tiled frame contains video imagery that has been “stitched” together either horizontally or vertically, to create a panoramic view. This can be done by capturing from two adjacent video cameras, with each having a field of view with a common side, such that when “stitched” together would create a panoramic view either horizontally or vertically. The viewer can adjust a sliding “window” to view any portion of the panorama in full screen.

This windowing needs to be performed by the decoder, by shifting the pixel column or row starting address of the memory being read, and displayed on the display device.

“Stereoscopic 3D Mode” is a mode that displays the two video sources [FIG. 1,2] and normally requires the tiled video stream [FIG. 3] to contain “left-eye” and “right-eye” camera views. The display device will display Stereoscopic 3D, in any of the 3D formats the display device can support, such as anaglyph, polarized, or field interleaved.

The viewer also has the choice to view the Stereoscopic video content in 2D, by selecting “Dual-View Mode” and manually choosing “left-eye” view [FIG. 1], or “right-eye” view [FIG. 2]

The display, if it has the capability to convert dual streams to anaglyph 3D, by the standard mathematical process, in prior art, the viewer will be capable to view anaglyph 3D, using colorized glasses.

The source material for each eye may also be encoded such that it is already in anaglyph format, in which case the TV will display the summation of the colorized “left-eye” view [FIG. 1] and “right-eye” view [FIG. 2]. The viewer will be capable to view anaglyph 3D, using colorized glasses.

The source material for each eye may also be encoded such that it is already in anaglyph format, in which case the TV will display the summation of the uncolorized 2D normal view [FIG. 1] and the combined colorized “right-eye” and “left-eye” views [FIG. 2]. The viewer will be capable of watching the content in a 2D mode without glasses, or to view anaglyph 3D, using colorized glasses.

If the TV is capable of generating polarized Stereoscopic 3D, from a dual stream of video, then the viewer will be capable of viewing Stereoscopic 3D using polarized glasses.

If the TV is capable of generating field-interleaved Stereoscopic 3D, from a dual stream of video, then the viewer will be capable of viewing Stereoscopic 3D using shutter glasses.

As can be seen from this invention, the capabilities enabled by having a source of dual streams of video presented to the display device, creates an enhanced viewing experience.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1) A method of combining two standard video streams, into one standard video stream, by tiling two lower resolution images frames into one higher resolution image frame, without loss of pixel data; this tiled image frame will hereinafter be called the “tiled frame”.

2) The method of encoding the tiled frame, in claim 1, in such a way that it can be encoded efficiently, by compression algorithms such as MPEG-2, MPEG-4, and WM-9.

3) The method of storing the tiled frame, in claim 1, by using standard recording devices that accept a single stream of video.

4) The method of transmitting the tiled frame, in claim 1, by using standard transmission devices that accept a single stream of video.

5) The method of receiving the tiled frame, in claim 1, by using standard reception devices that accept a single stream of video.

6) The method of decoding the tiled frame, in claim 1, into two standard video streams.

7) The method of displaying the two decoded video streams on a display device, such as a TV, projector, or computer monitor.

8) The method of claim 7, in which the display device is used to display regular “2D” video, in 2D Mode.

9) The method of claim 7, in which the display device is used to display one of the two video sources as regular “2D” video, in a user (viewer) selectable Dual-View Mode. The viewer can manually select, from two camera views that have been encoded, for example.

10) The method of claim 7, in which the display device is used to display the two combined video sources that have been “stitched” together either horizontally or vertically, then displayed as regular “2D” video, in a viewer selectable Pan-and-Scan Mode. The viewer can manually adjust the position of the full screen display within the dual-frame “stitched” panoramic frame, from two adjacent camera views that have been encoded, for example.

11) The method of claim 7, in which the display device is used to display the two video sources as Stereoscopic 3D, in any of the 3D formats the display device can support, such as anaglyph, polarized, or field or frame interleaved; this is the Stereoscopic 3D Mode, and normally requires the dual video stream to contain “left-eye” and “right-eye” views, but the user may wish to view the video content in 2D mode, which is also supported by this invention.
